(19) United States
(12) Patent Application Publication
(10) Pub. No.: US 2016/0100708 A1
(43) Pub. Date: Apr. 14, 2016

(54) APPARATUS AND METHOD FOR PREPARING CRISPY RICE

(71) Applicant: Soheil Shahrooz, New York, NY (US)

(72) Inventor: Soheil Shahrooz, New York, NY (US)

(21) Appl. No.: 14/878,335

(22) Filed: Oct. 8, 2015

Related U.S. Application Data
(60) Provisional application No. 62/061,265, filed on Oct. 8, 2014.

(51) Int. Cl. A47J 27/62; A47J 27/00; A23L 1/182

(52) U.S. Cl. CPC A47J 27/62; A23L 1/182; A47J 27/002; A23V 2002/00

(57) ABSTRACT

An apparatus for preparing crispy rice is shown and described. The rice cooker may include a lid assembly, a pan assembly, a cooking assembly and a heater assembly. The pan may include perforations configured to allow oil to flow from the pan to a rice mixture in the cooking assembly.

### CROSS-REFERENCE TO RELATED APPLICATION

This application claims the benefit from U.S. Provisional Patent Application No. 62/061,265 entitled “Apparatus and Method for Preparing Crispy Rice” filed on Oct. 8, 2014, which is hereby incorporated in its entirety by reference.

### FIELD OF USE

The present invention is generally related to an apparatus and method for preparing crispy rice.

### BACKGROUND

Conventional rice cookers may not be designed to prepare certain rice dishes. Specifically, conventional rice cookers are not ideal for preparing rice dishes that require the rice to become crispy, such as Persian rice (e.g., tandig). Because conventional rice cookers may be designed to avoid burning, crisping of the rice may be very difficult in these types of rice cookers.

In order to make crispy rice, therefore, one typically must cook the rice and then drop the rice into a frying pan with oil to crisp the rice. This is time consuming and requires multiple kitchen implements to accomplish. This requires the user to wash these multiple implements.

### SUMMARY

The present teachings relate to an apparatus for preparing crispy rice. The rice cooker may include a lid assembly, a pan assembly, a cooking assembly and a heater assembly. The heater assembly may be positioned within the cooking assembly or may be attached to the cooking assembly. The pan assembly may comprise a container portion on which the rice may rest during the cooking process. The pan assembly may include a receptacle for oil, the receptacle comprising perforations configured to allow oil to flow from the pan assembly to a rice mixture in the container portion of the pan assembly.

In one embodiment, the receptacle is a tube configured to accept oil.

In one embodiment, the rice cooker comprises a microcomputer that controls the temperature and timing of the cooking process for preparing the crispy rice. In an embodiment, the microcomputer is programmed to adjust the cooking time, the cooking temperature, or both the cooking time and the cooking temperature based on input from the user.

In one embodiment, the rice cooker comprises at least one sensor detects the completeness of the cooking cycle of the crispy rice and the at least one sensor provides the microcomputer with a signal to stop the cooking process at a preprogrammed level of completeness.

In an embodiment, the microcomputer is programmed to provide an alert to the user to add oil to the receptacle.

In one embodiment, a user may select the level of completeness of the crispy rice.

In one embodiment, the lid assembly includes a vent.

### BRIEF DESCRIPTION OF THE DRAWINGS

The present teachings may be better understood by reference to the following detailed description taken in connection with the following illustrations, wherein:

FIG. 1 is a perspective view of an embodiment of a crispy rice cooker of the present teachings.

FIG. 2 is an exploded view of the crispy rice cooker.

FIG. 3 is an exploded view of the crispy rice cooker.

FIG. 4 is a top view of the crispy rice cooker.

FIG. 5 is a bottom view of the crispy rice cooker.

FIG. 6 is a front view of the crispy rice cooker.

FIG. 7 is a rear view of the crispy rice cooker.

FIG. 8 is a first side view of the crispy rice cooker.

FIG. 9 is a second side view of the crispy rice cooker.

FIG. 10 is a partially exploded view of the crispy rice cooker.

FIG. 11 is an exploded view of a lid, window and window retainer ring of the crispy rice cooker.

FIG. 12 is a cross-sectional view of a portion of the crispy rice cooker.

FIG. 13 is a perspective view of a portion of the crispy rice cooker.

FIG. 14 is a first perspective view of an embodiment of an assembly process of the crispy rice cooker.

FIG. 15 is a second perspective view of the embodiment of the assembly process of the crispy rice cooker.

FIG. 16 is a perspective view of another embodiment of the crispy rice cooker.

FIG. 17 is a perspective view of an embodiment of the crispy rice cooker in which the lid is open.

FIG. 18 is a perspective view of an embodiment of the crispy rice cooker with the lid closed.

FIG. 19 is a front view of an embodiment of the crispy rice cooker.

### DETAILED DESCRIPTION

Reference will now be made in detail to exemplary embodiments of the present teachings, examples of which are illustrated in the accompanying drawings. It is to be understood that other embodiments may be utilized and structural and functional changes may be made without departing from the respective scope of the present teachings. Moreover, features of the various embodiments may be combined or altered without departing from the scope of the present teachings. As such, the following description is presented by way of illustration only and should not limit in any way the various alternatives and modifications that may be made to the illustrated embodiments and still be within the spirit and scope of the present teachings.

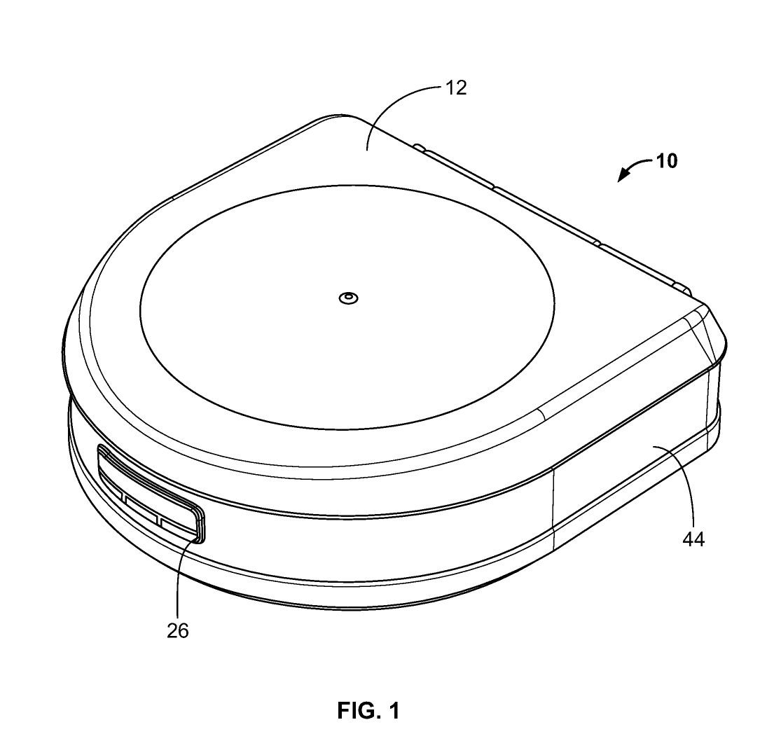

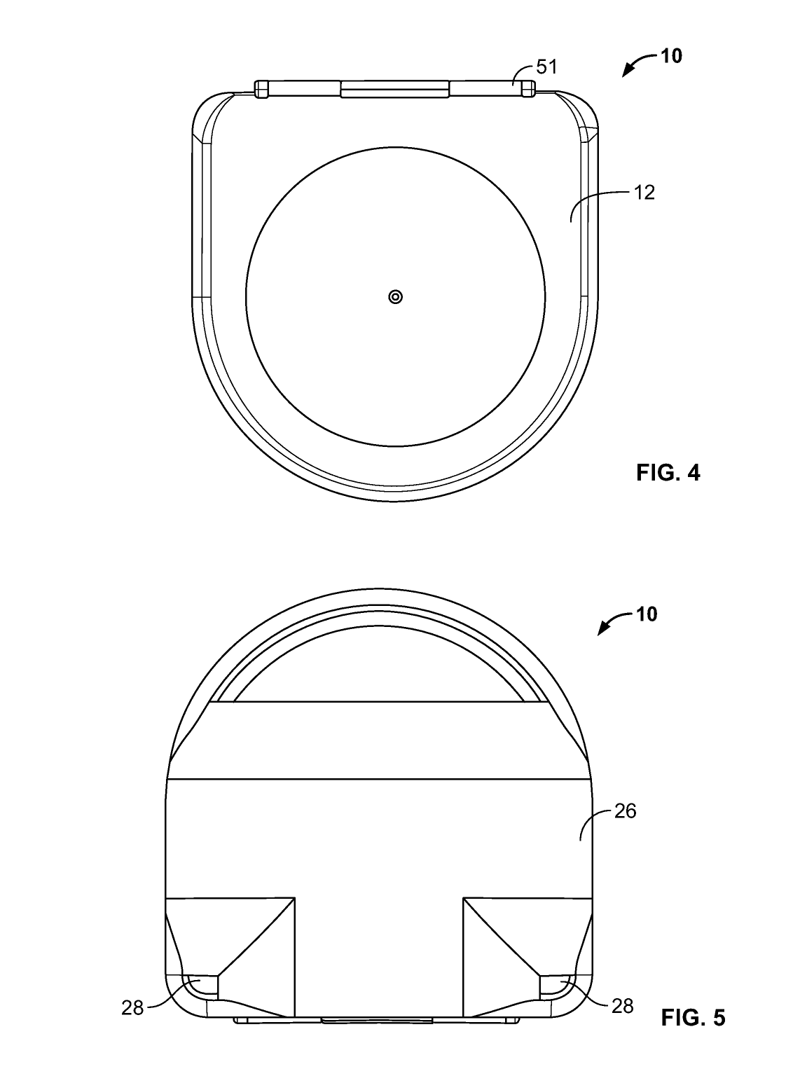

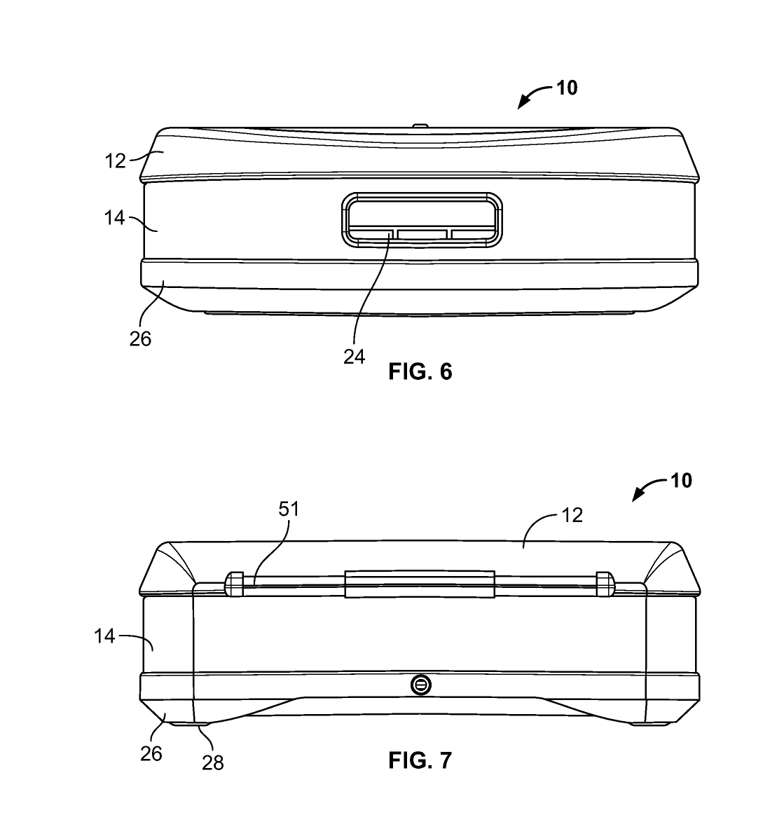

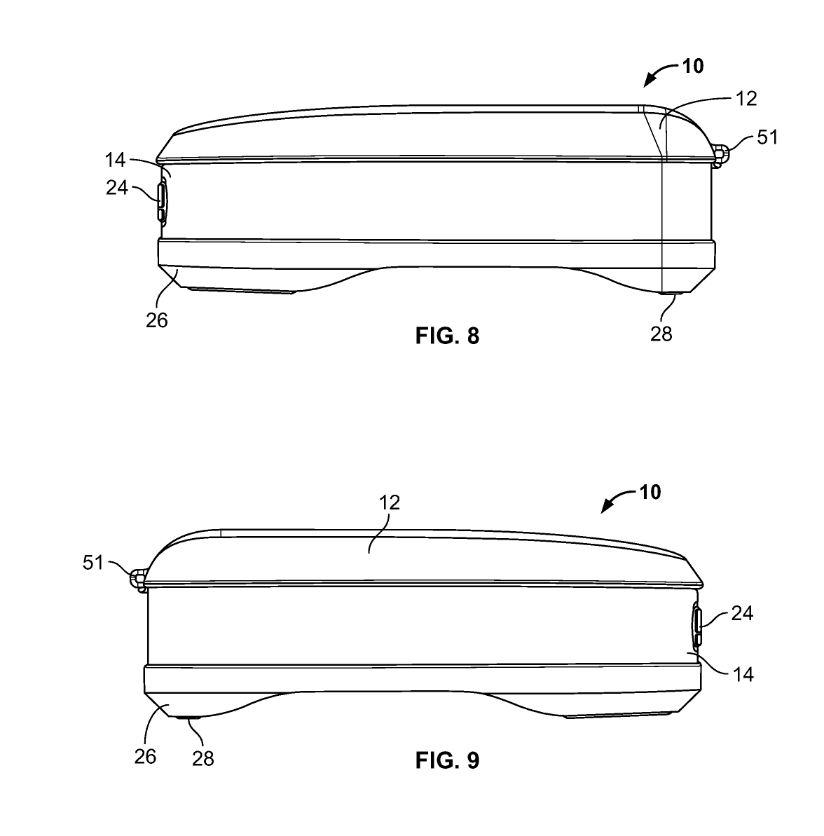

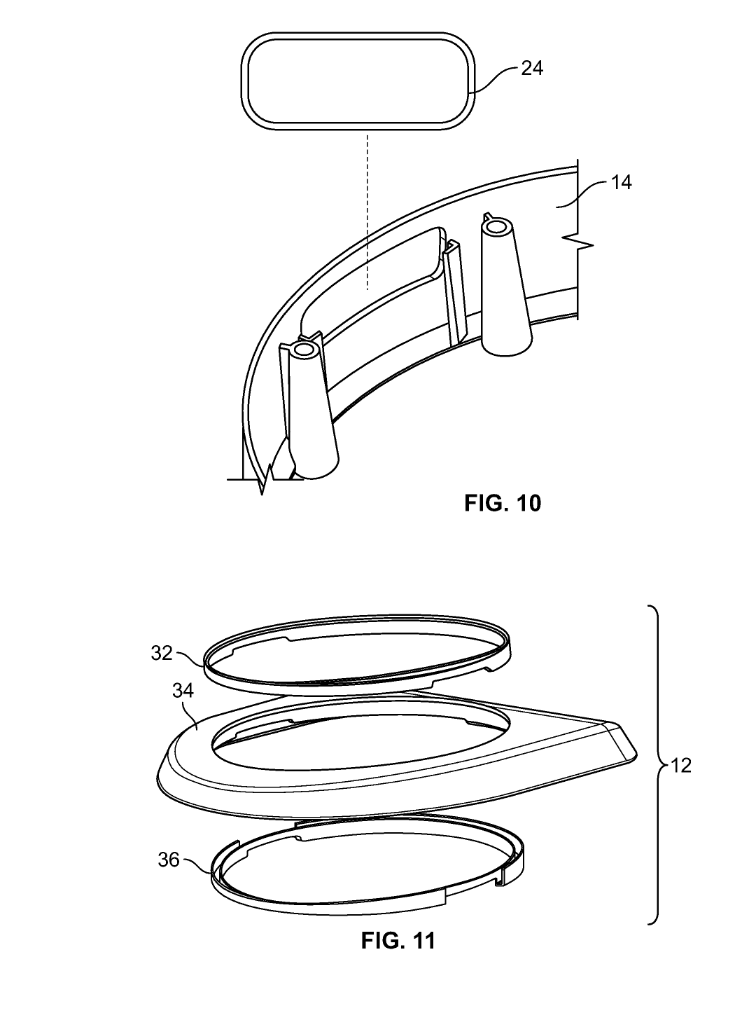

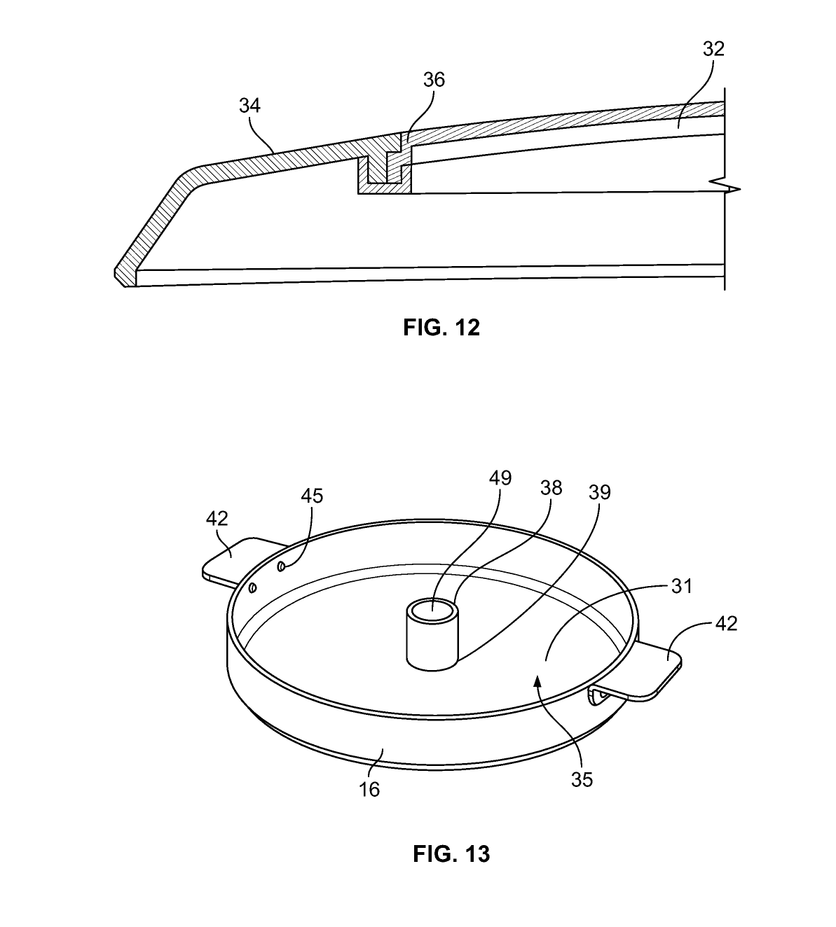

An embodiment of a crispy rice cooker 10 is shown in FIGS. 1-9. It should be understood, however, that this embodiment is merely exemplary. The present teachings include variations of the embodiments shown herein. Different embodiments of components of the crispy rice cooker 10 are shown and described. It should be understood that these various embodiments may be substituted with the other embodiments described herein to achieve a rice cooker with any combination of such features.

The rice cooker 10 may include a lid assembly 12, a pan assembly 16, and a cooking assembly 44. The cooking assembly 44 may include a heater assembly 18 of any appropriate configuration and type. The heater assembly 18 may provide the required heat to the cooking assembly 44 as described in more detail below. The cooking assembly 44 may include an area for operatively accepting the pan assembly 16. By way of a non-limiting example, the heater assembly 18 may include an electrical heating coil configured to provide enough heat to cook the rice and then fry it (crisp it) to the appropriate texture.

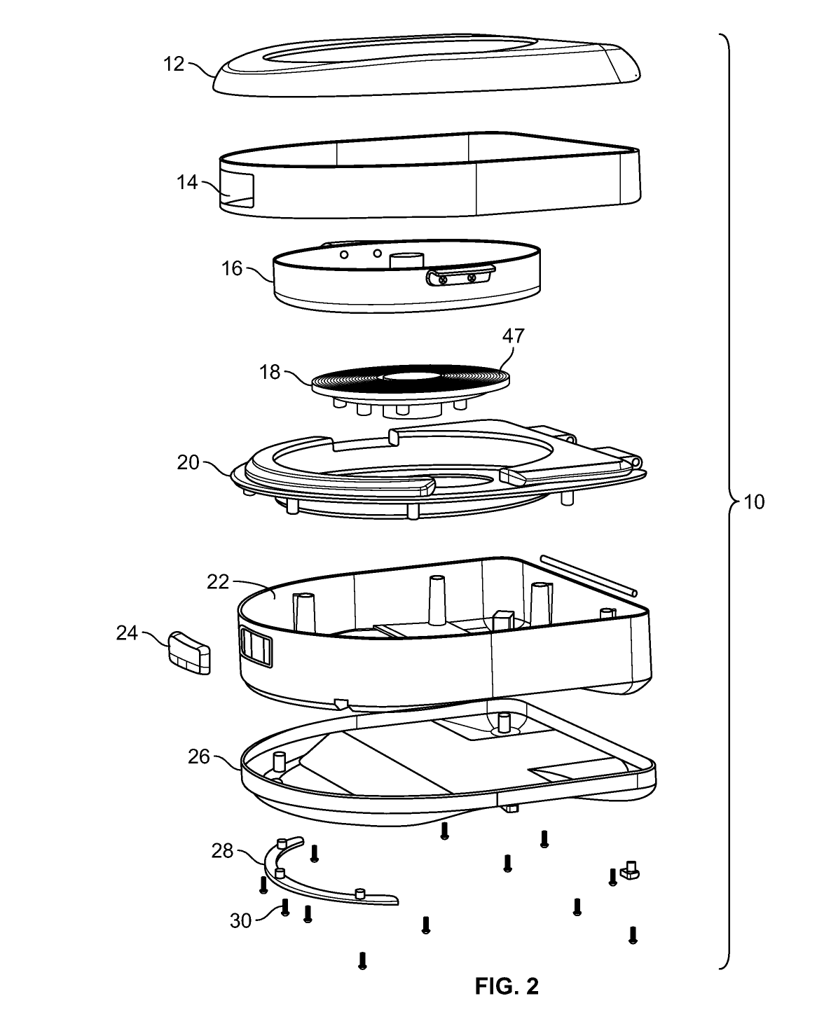

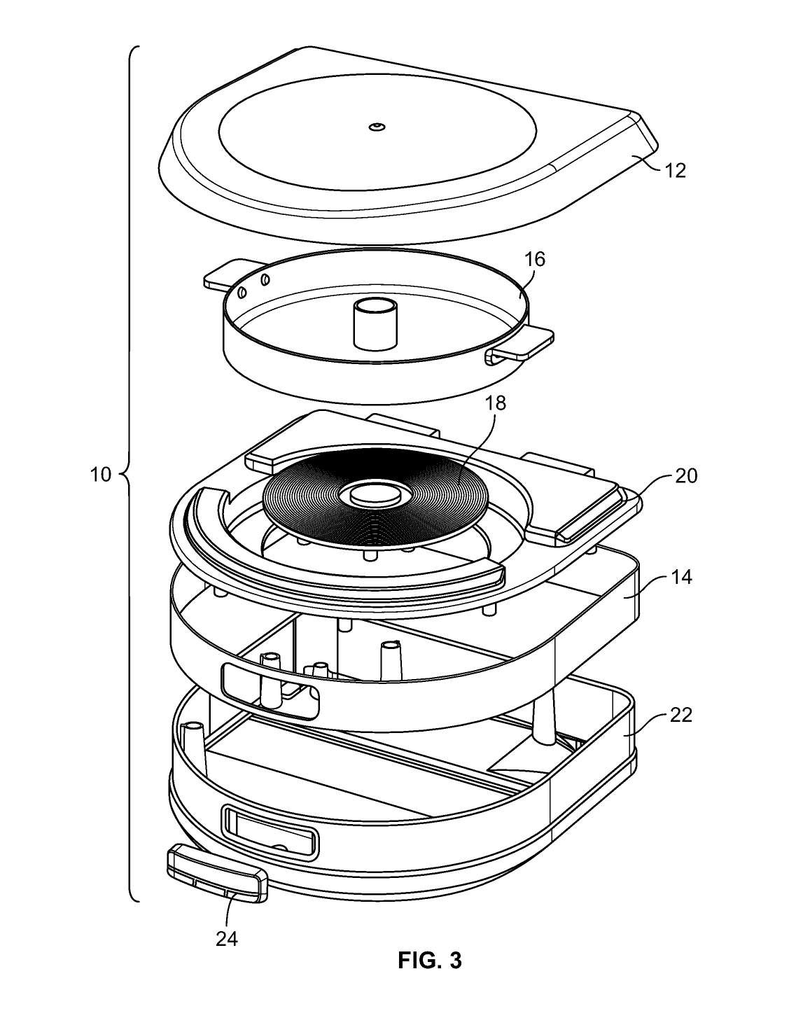

As shown in particular in FIGS. 2 and 3, the pan assembly 16 may be of any appropriate configuration for containing rice, water and other ingredients during the cooking process. The pan assembly 16 may be of any appropriate configuration and size. The present teachings are not limited to the configuration and size shown and described herein. By way of a non-limiting example, the pan assembly 16 may be of a shape and size to hold a predetermined number of servings of rice, such as one, two, three, four, etc. Further still, the pan assembly 16 may be configured as a commercial version that may hold multiples of servings of rice, e.g., five through twenty, etc. The pan assembly 16 may be positioned above the cooking assembly 44 and be selectively positioned into and out of the cooking assembly 44.

The pan assembly 16 may include a container portion 31 that may include a generally flat bottom portion 35 on which the rice may rest during cooking The flat portion 35 may include a non-stick coating to prevent the rice from sticking to the pan. The pan assembly 16 may include at least one tube 38 attached to the container portion 31 in any appropriate manner, including, without limitation via welding, fastening, adhering or monolithically forming therewith. The tube 38 may include a plurality of perforations 39 placed in proximity to the bottom portion 35. The tube 38 may be configured to accept oil therein. The oil placed in the pan assembly 16 may flow through the perforations 39 and into the container portion 31 as necessary to cook the rice as described in more detail below. The pan assembly may include any number or tubes 38. The pan assembly 16 may be formed from any appropriate material, including without limitation, metal (such as aluminum, stainless steel, etc.), ceramic or any other such appropriate material. Any appropriate number of tubes 38 and any appropriate number and shape of perforations 39 may be utilized without departing from the present teachings.

In one embodiment, the pan assembly 16 comprises a plurality of tubes 38, each configured to accept oil.

In one embodiment, the cooking assembly 44 may further include a top part 20, a body insert 22 and a base 26 joined by any suitable means including, without limitation, fastening (such as with screws), welding, adhering or the like. As shown, the heater assembly 18 may be positioned in the top part 20, which may be inserted into the body insert 22 and the base 26 may be attached to the bottom thereof. The heater assembly 16 is positioned relative to the pan assembly 18 to provide heat to the pan assembly 16 to cook the rice. In one embodiment, the top part 20 may be configured to operatively accept the pan assembly 16 so as to operatively position the pan assembly 16 with respect to the heater assembly 18 to heat the pan assembly 16 as required to cook the rice. Alternatively, the cooking assembly could be formed as one piece, i.e., monolithically, that includes a top part 20, a body insert 22 and a base 26.

In one embodiment, the pan assembly 16 may fit on top of or inside the cooking assembly 44. The pan assembly 16 may include a handle 42 for easy removal from the rice cooker 10 and for positioning the pan assembly 16 above or more specifically within the cooking assembly 44. (See FIG. 5). More specifically, the handle 42 may be of a configuration to assist the user with moving the pan assembly 16 into operative position with respect to the heater assembly 18 and to remove the pan assembly 16 from the cooking assembly 44. Any number of handles 42 may be utilized, e.g., two. The handles 42 may be attached such as through a rivet or a plurality of rivets 45. As noted above, the tube 38 of the pan assembly 16 may accept the oil necessary to crisp the rice. Specifically, oil may be placed in the pan assembly 16—via the tube 38—to facilitate crisping of the rice. The oil may flow through the perforations 39 into the pan assembly 16 and onto the rice or rice/water mixture within the cooking assembly 44 at a predetermined time during the cooking process. Handles may be formed of a generally heat resistant material to avoid becoming over heated.

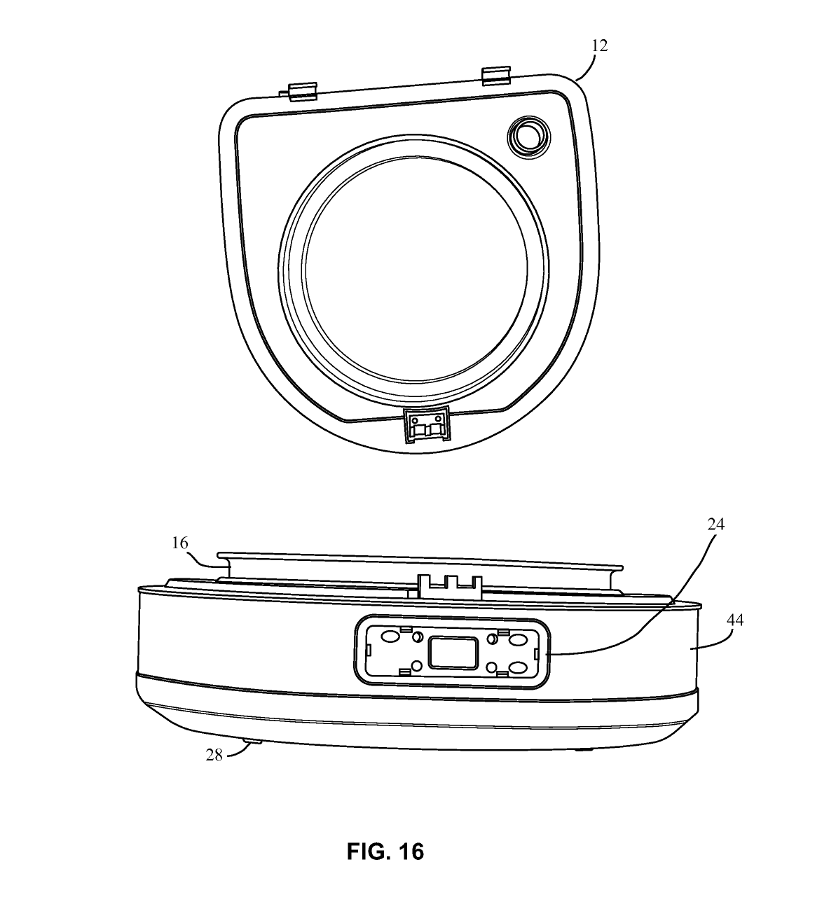

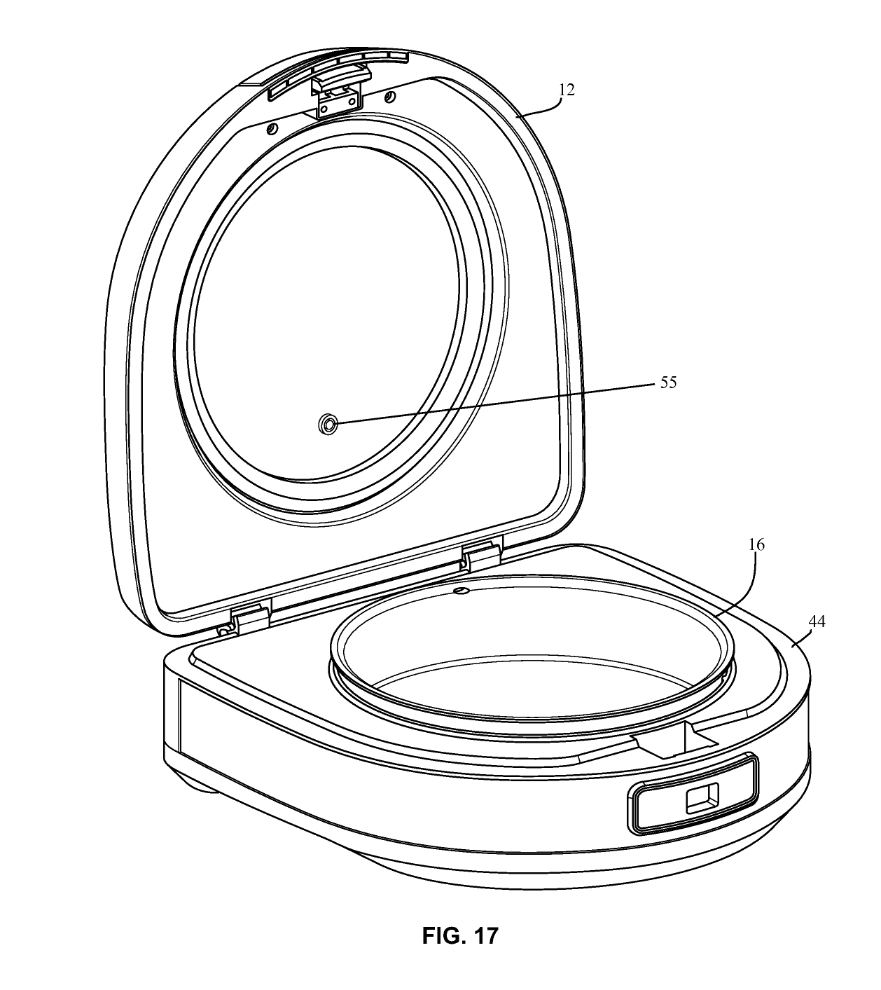

In one embodiment, there may be a gap between the pan assembly 16 and the cooking assembly 44 to enable removal of the pan assembly 16 from the cooking assembly 44. (See e.g., FIGS. 16 and 17). This allows a user to insert their hand to make disassembly and removal easier.

In one embodiment, the pan assembly 16 may include a lip to facilitate removal of the pan assembly 16 from the cooking assembly 44.

For example, the tube 38 may be positioned in a generally center portion of the pan assembly 16 (or more specifically generally in the center of the container portion 31). The tube 38 may include a top open portion to help facilitate pouring of the oil therein. The user may add the oil into the open center 49, such as the one shown in FIG. 13. The oil may be added at the start of the cooking process or during the cooking process—the present teachings are not limited to a specific embodiment. During the cooking process the oil may be distributed through the rice mixture as required to crisp the oil. The oil may be added at anytime during the cooking process. In one embodiment, the oil may be added after the rice has finished the initial cooking process.

The heater assembly 18 may include any appropriate means for heating such as a heating coil or an electric hot plate. In one embodiment, the heater assembly may include heating coil 47. The heating coil 47 may be an induction heating coil; however, the present teachings are not limited to such. Any appropriate heating system may be utilized. The rice cooker 10 may include a control means for controlling the power to the heating coil 47 such that the rice can be cooked to different levels of crispiness (e.g., light, medium, or dark). Any appropriate configuration of controller may be used without departing from the present teachings.

In one embodiment, the heater assembly 18 may be attached to the cooking assembly 44 by any suitable means including, without limitation, fastening (such as with screws), welding, adhering or the like. In another embodiment, the heater assembly 18 may not be attached to the cooking assembly 44 but is in close proximity to the cooking assembly 44 such that heat from the heater assembly 18 may be used to cook the rice mixture contained in the cooking assembly 44.

In one embodiment, the heater assembly 18 may be positioned within the cooking assembly 44. For example, the heater assembly 18 may be positioned in the body insert 22 and/or the top part 20 of the cooking assembly 44. (See FIG. 3). In these embodiments, the body insert 22, top part 20 and/or base 26 may generally encapsulate the heater assembly to generally protect the heater assembly 18 from environmental conditions. The cooking assembly 44 may further include a metal wrap 14 to further encapsulate the cooking assembly 44. The metal wrap 14 may provide a further aesthetic finish and may further provide additional thermal protection.

In one embodiment, the lid assembly 12 may include a window 32, a lid 34, and a window retainer ring 36. The lid assembly 12 may be attached to the cooking assembly 44 by any suitable means including, without limitation, fastening (such as with screws), welding, adhering or the like. For example, the lid assembly 12 may be attached to the base 26 of the cooking assembly 44. In one embodiment, the window retainer ring 36 may be press fit or sonic welded into the top of the lid 34. The window 32 may be transparent to allow a user to view the pan assembly 16 to see the rice during the cooking process. In other embodiments, however, the window 32 may be opaque. The window 32 may be made of any appropriate material, including, without limitation, glass, plastic or the like.

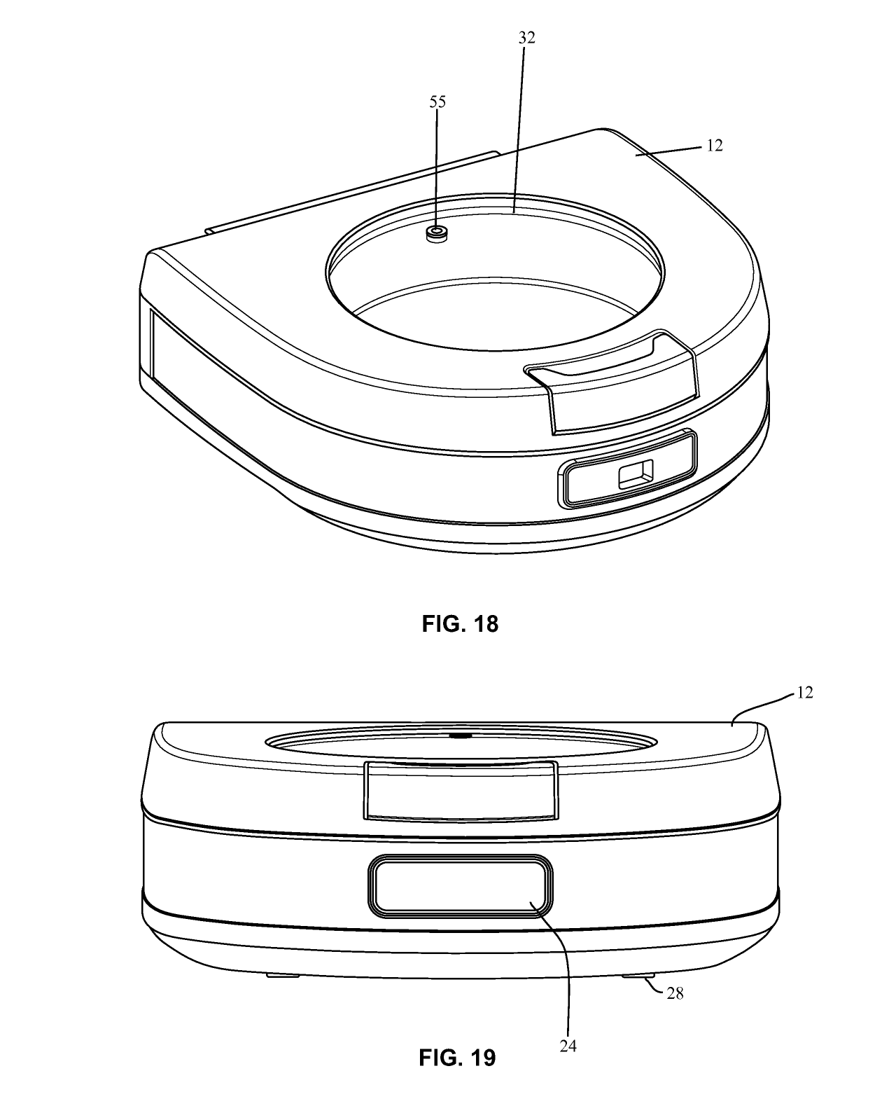

In one embodiment, a vent 55 may be included in the lid assembly to prevent condensation from forming inside the rice cooker. The vent may be located in the window 32 as depicted in FIG. 18. The vent 55 may be located anywhere on the lid assembly to facilitate venting of the inside of the rice cooker while it is in use.

The rice cooker 10 may further include a control panel 24 that may be configured to operate the rice cooker 10. The control panel 24 may include actuation buttons or a touch screen that may operate the rice cooker 10, e.g., to control the settings thereof. Further the control panel 24 may include a display that indicates the operation of the rice cooker 10. For example, the control panel 24 may identify the time remaining on a cooking cycle, the cooking cycle at which it is currently operating, the temperature of the heater assembly 18 (or more specifically, the pan assembly 16), or any combination of such. The control panel 24 may be of any appropriate configuration. By way of a non-limiting example, the control panel 24 may include an LCD button assembly. In these embodiments, the control panel 24 may be inserted into openings in the metal wrap 14 and/or the body insert 22 as shown in the drawings. In one embodiment, the display may include a touch screen with a control panel added directly thereto.

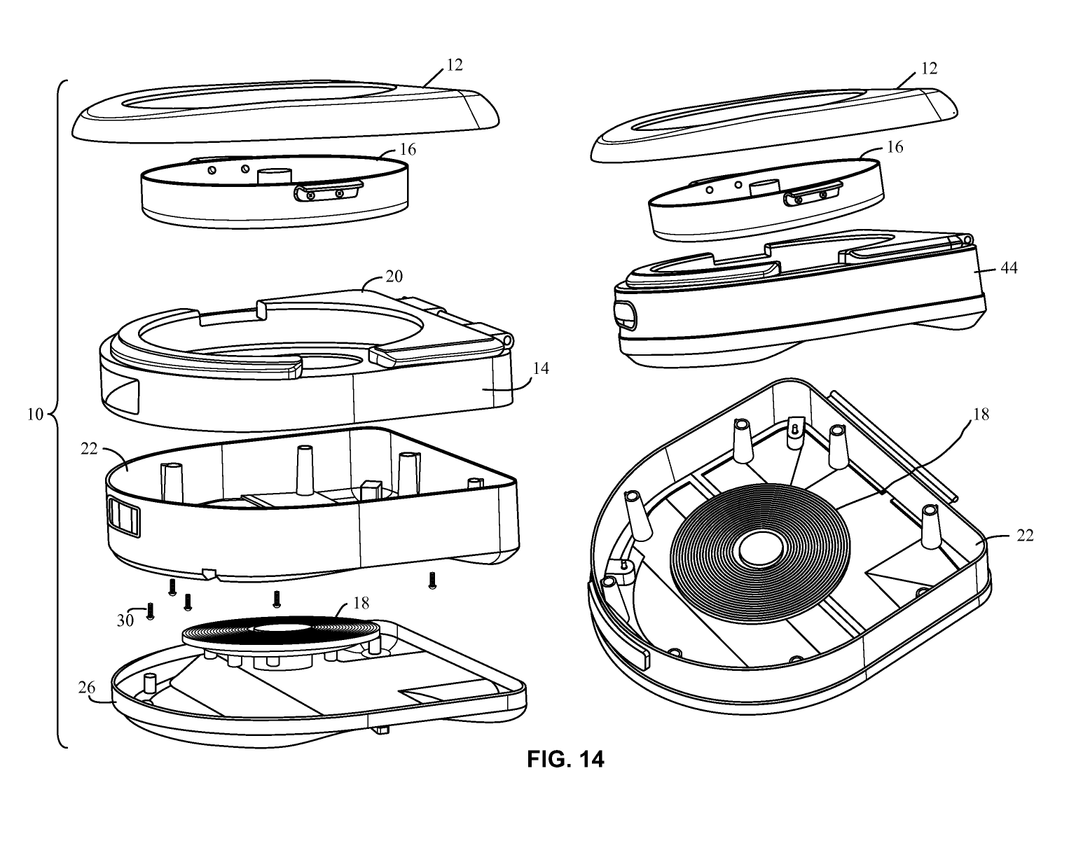

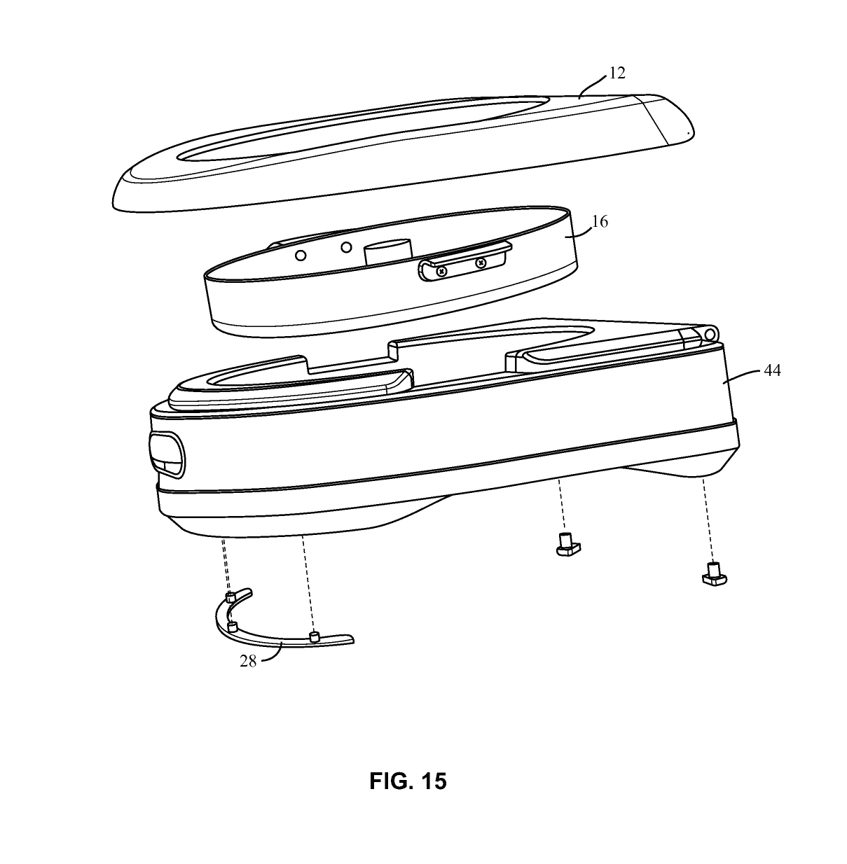

The rice cooker 10 may be assembled in any appropriate manner. By way of a non-limiting example, the rice cooker 10 may be attached as shown in FIGS. 14 and 15. In these embodiments, the heater assembly 18 may be inserted into the top part 20 and then the assembly may be inserted into the body insert 22. The control panel 24 may be attached at this point or in advance of the assembly be attached. The base 26 may be put in operative position with respect to the body insert 22. Non-skid feet 28 may be attached to the body of the base 26 to prevent unwanted movement of the rice cooker 10 while sitting on a surface, such as a kitchen countertop. Screws 30 may be used to attach the non-skid feet 28 with the base 26. Similarly, screws may be used to attach the top part 20, body insert 22, and base 26 together, along with the heater assembly 18.

Next, the lid assembly 12 may be assembled. In these embodiments, the window 32, the lid 34, and the window retainer ring 36 may be attached together, such as being snap fit together, fastened (such as with screws), adhered or welded together. The lid assembly 12 may then be moveably attached with the cooking assembly 44. In this embodiment, the lid assembly 12 may be pivotally attached with the cooking assembly 44 in any appropriate manner, such as with a fastener or the like. By way of a non-limiting example, a hinge 51 may be utilized to pivotally attach the lid assembly 12 with the cooking assembly 44. The hinge 51 may be of any appropriate configuration and type. The lid assembly 12 may be pivoted with respect to the cooking assembly 44 to create an opening through which the pan assembly 16 may be inserted into the cooking assembly 44 such that it may be in an operative position with respect to the heater assembly 18.

As shown in FIG. 15 if the non-skid feet 28 have not already been attached, they may be attached after assembly of the rest of the rice cooker 10.

The rice cooker 10 may include a power cord (not shown) which may provide the necessary power to the control panel 24 and/or the heater assembly 18. The power cord may be of any appropriate configuration, e.g., 120V or 220V. In one embodiment, the power cord may be detachable. Further still, the rice cooker 10 may include a battery to power such. In these embodiments, the battery may be rechargeable. This may allow a user to either operate the rice cooker 10 by inserting the power cord into a power source or operating such through use of the battery.

All of the cooking steps may be controlled by a microcomputer that controls the temperature and timing of the cooking process. The microcomputer may be programmed to adjust the temperature and cooking time depending on input from the user. For example, the microcomputer could be programmed such that the rice is cooked at 288° F. for about 10 minutes for light crispy rice, for about 14 minutes for medium crispy rice, and for about 18 minutes for dark crispy rice. Alternatively, sensors may be used to detect the completeness of the cooking cycle of the rice and stop the cooking process when the correct level has been achieved.

In one embodiment, a user can control the crispiness of the rice by selecting the appropriate level of doneness on the control panel 24 or button assembly on the rice cooker 10. The display panel 24 may be any appropriate means for displaying and/or inputting information, including, but not limited to an LCD, LED or OLED display. The button assembly may include buttons or knobs that allow a user to select a desired outcome.

A method of preparing crispy rice may include cooking a desired amount of rice in a suitable amount of water (e.g., one cup of rice and one cup of water). These may be added to the cooking assembly 44, or more specifically to the pan assembly 16, of the rice cooker 10. In one embodiment, a button or display on the rice cooker 10 may be operatively connected to the heater assembly 18 that controls the temperature and/or time of the cooking process as described above.

Oil may be added to the pan assembly 16 at any time during the cooking process, including at the very beginning of the cooking process. In one embodiment, oil may be added to the pan assembly 16 after the rice has been cooked in the water. In one embodiment, when the rice is done cooking in the water, the rice cooker 10 may alert the user that the cooking process is complete and that oil may be added to the pan assembly 16. Non-limiting examples of the types of alerts include an alarm, a buzzer, or a flashing display. Regardless of when added, the user may pivot the lid assembly 12 to gain access to the pan assembly 16.

In one embodiment, oil may be added via the opening of the tube 38. The user may add the oil to the tube 38 and then may close the lid assembly 12. The user may lift the lid assembly 12 may stop the cooking of the rice (e.g., stop operation of the heater assembly 18). As noted above, the oil may generally disperse through the perforations 39 into the pan assembly 16. In these embodiments, the perforations 39 may be generally evenly spaced around the tube 38 so that the oil may be generally evenly dispersed within the pan assembly 16 to generally evenly crisp the rice as desired. The final crispiness of the rice can be pre-selected at any time during the cooking process. The rice cooker 10 may include a display such as an LCD, LED or OLED display, buttons, or knobs that allow a user to select the final crispiness of the rice. For example, the rice cooker 10 may include a button or buttons that allow a user to select rice that is “light,” “medium,' or “dark.”

Although embodiments of the present teachings have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The claims as follows are intended to include all modifications and alterations insofar as they come within the scope of the claims or the equivalent thereof

What is claimed is:

1. A rice cooker for preparing crispy rice comprising:
a lid assembly;
a pan assembly comprising a container portion on which rice may rest during cooking; and
a cooking assembly under the pan assembly,
wherein the pan assembly comprises a receptacle for oil, the receptacle comprising perforations configured to allow oil to flow into the rice on the container portion.

2. The rice cooker of claim 1, wherein the receptacle is a tube configured to accept oil.

3. The rice cooker of claim 1 further comprising a microcomputer that controls the temperature and timing of the cooking process for preparing the crispy rice.

4. The rice cooker of claim 3, wherein the microcomputer is programmed to adjust the cooking time, the cooking temperature, or both the cooking time and the cooking temperature based on input from the user.

5. The rice cooker of claim 3, wherein at least one sensor detects the completeness of the cooking cycle of the crispy rice and the at least one sensor provides the microcomputer with a signal to stop the cooking process at a preprogrammed level of completeness.

6. The rice cooker of claim 3, wherein the microcomputer is programmed to provide an alert to the user to add oil to the receptacle.

7. The rice cooker of claim 1, wherein a user may select the level of completeness of the crispy rice.

8. The rice cooker of claim 1, wherein the lid assembly includes a vent.

9. A rice cooker for preparing crispy rice comprising:
a lid assembly;
a pan assembly comprising a container portion on which the rice may rest during cooking; wherein the pan assembly comprises a receptacle for oil, the receptacle comprising perforations configured to allow oil to flow into the rice on the container portion;
a cooking assembly under the pan assembly; and
a microcomputer programmed to control the temperature and timing of the cooking process for preparing the crispy rice.

10. The rice cooker of claim 9, wherein the receptacle is a tube configured to accept oil.

11. The rice cooker of claim 9, wherein the microcomputer is programmed to adjust the cooking time, the cooking temperature, or both the cooking time and the cooking temperature based on input from the user.

12. The rice cooker of claim 9, wherein at least one sensor detects the completeness of the cooking cycle of the crispy rice and the at least one sensor provides the microcomputer with a signal to stop the cooking process at a preprogrammed level of completeness.

13. The rice cooker of claim 9, wherein the microcomputer is programmed to provide an alert to the user to add oil to the receptacle.

14. The rice cooker of claim 9, wherein a user may select the level of completeness of the crispy rice.

15. A rice cooker for preparing crispy rice comprising:
a lid assembly;
a pan assembly comprising a container portion on which the rice may rest during cooking; and
a cooking assembly under the pan assembly comprising a heater assembly,
wherein the heater assembly is configured to provide heat to the pan assembly to crisp the rice in the container portion .

16. The rice cooker of claim 15 further comprising a microcomputer that controls the temperature and timing of the cooking process for preparing the crispy rice.

17. The rice cooker of claim 16, wherein the microcomputer is programmed to adjust the cooking time, the cooking temperature, or both the cooking time and the cooking temperature based on input from the user.

18. The rice cooker of claim 16, wherein at least one sensor detects the completeness of the cooking cycle of the crispy rice and the at least one sensor provides the microcomputer with a signal to stop the cooking process at a preprogrammed level of completeness.

19. The rice cooker of claim 16, wherein the microcomputer is programmed to provide an alert to the user to add oil to the pan assembly.

20. The rice cooker of claim 15, wherein a user may select the level of completeness of the crispy rice.
